(19) United States
(12) Patent Application Publication
(10) Pub. No.: US 2022/0270495 A1
(43) Pub. Date: Aug. 25, 2022

(54) METHOD FOR DETERMINING THE PATH OF AN UNMANNED AERIAL DEVICE AND OTHER ASSOCIATED METHODS

(71) Applicant: UAVIA, Vitry-sur- Seine (FR)

(72) Inventor: Pierre PELE, Vitry-sur-Seine (FR)

(21) Appl. No.: 17/623,693

(22) PCT Filed: Jul. 1, 2020
(86) PCT No.: PCT/IB2020/056227

§ 371 Date: Jan. 10, 2022

(30) Foreign Application Priority Data
Jul. 1, 2019 (FR) 1907291

(51) Int. Cl. G08G 5/00; G05D 1/02; B64C 39/02

(52) U.S. Cl. CPC G08G 5/006; G08G 5/003; G05D 1/0204; B64C 39/024; B64C 2201/12

(57) ABSTRACT

A modeling method using digital processing of a three-dimensional environment to establish pathways for unmanned aerial devices which are optimized according to different priorities, the method being characterized in that it comprises the following digital processing steps:
(a) providing a three-dimensional model of volumes (PEXi) wherein flight is prohibited,
(b) subdividing the model into individual elements (PVk),
(c) determining a center (Pk) for each individual element,
(d) establishing and memorizing a graph, the nodes (Pk, Ik) of which are formed by at least one portion of the centers, and the branches of which are weighted by the distances between the nodes and by at least one weighting associated with a given priority.

A method is also proposed for determining, using an unmanned aerial device, a path between two points in a three-dimensional space modeled by such a graph, and steering methods using such a determination.

### FIELD OF THE INVENTION

The present invention relates generally to unmanned aerial devices or drones, and in particular to the determination of paths for drones in constrained environments.

### PRIOR ART

Surveillance drones are increasingly being used for surveillance, particularly for monitoring structures, sensitive sites, etc.

In addition, solutions are known in the literature to make drones describe imposed paths.

In the field of manned flight, a flight plan is a sequence of waypoints without vertical dimensions (see for example EP1614086A2) chosen in advance by the user in accordance with environmental and material constraints.

This document describes techniques for tracking the theoretical trajectory, taking as input a list of coordinates of waypoints and data from different sensors (Lidar, laser, etc.) which are processed to dynamically modify said trajectory.

The current prior art does not propose a technique allowing the automatic establishment of a flight program under environmental and material constraints on the one hand and under higher level constraints determined by the user on the other hand.

Thus, in the current prior art, it is the user of a UAV who is in charge of constructing the list of waypoints allowing the device to reach the destination. The user has to construct this path by avoiding obstacles, taking into account the uncertainty of the UAV positioning, checking that the energy necessary for the UAV to cover the path is available, etc.

Still in the current prior art, a safety pilot must be present during the execution of the automatic mission of the UAV, so as to be able to take over in case of a problem. He will then be in charge of making the right decisions regarding the trajectories allowing the UAV to reach a safe zone.

### SUMMARY OF THE INVENTION

The present invention proposes to improve the generation of automatic flight programs by limiting the need for human intervention during flight, with great flexibility in the determination of the flight path.

According to a first aspect, a method is proposed for modeling a three-dimensional environment by digital processing in order to establish pathways for unmanned aerial devices optimized according to different priorities, characterized in that it comprises the following digital processing steps:

(a) providing a three-dimensional model of volumes (PEXi) in which flight is prohibited,

(b) subdividing the model into individual elements (PVk),

(c) determining a center (Pk) for each individual element,

(d) establishing and memorizing a graph, the nodes (Pk, Ik) of which are formed by at least one portion of said centers, and the branches of which are weighted by the distances between the nodes and by at least one weighting associated with a given priority.

This method advantageously but optionally includes the following additional features, taken individually or in any combination that a person skilled in the art would consider to be technically compatible:
the priorities include at least two priorities among an absolute distance priority, a travel time priority, an energy consumption priority and a risk priority.
at least one of the weightings depends on a constraint affecting all the branches.
said constraint comprises a constraint vector affecting all branches.
the constraint vector is a wind vector, with each branch having a pair of weights associated with the direction of travel respectively, and each weight being distinctly subject to the wind vector.
said weighting is such that different weights are assigned to the same branch depending on the direction of travel, so as to generate preferred directions of travel.
said weighting is based on a mapping defining different levels of constraints depending on the location in a flight space.
the constraint levels are included in a group that includes a maximum allowable speed constraint and a risk constraint.
the constraint is able to take a value such that the corresponding zone becomes a no-fly zone.
step (a) includes providing a three-dimensional model with volumes (PEXi) in which flight is physically impossible, and reprocessing this model with static safety margin data.
step (a) comprises the subdivision of the three-dimensional model into horizontal slices (Txy), the projection of the volumes on a horizontal plane being the same throughout the thickness of each slice, and the implementation of a subdivision into individual elements in each horizontal plane.
the subdivision is done by triangulation.
the triangulation is a Delaunay triangulation.
step (d) involves establishing graph branches between nodes located in adjacent horizontal planes using a distance minimization approach.

According to a second aspect, a method is proposed for determining by an unmanned aerial device a path between two points in a three-dimensional space modeled by a graph obtained by the modeling method as defined above, characterized in that it comprises the following steps:
determining a priority for the route,
taking into consideration or establishing a given graph corresponding to the determined priority, and
defining the route, on board the device, by a best path calculation in said given graph.

This method advantageously but optionally includes the following additional features, taken individually or in any combination that a person skilled in the art would consider to be technically compatible:
the step of weighting the branches of the graph is implemented by remotely receiving a starting graph with unweighted branches, and weighting, on board the device, said branches according to the priority.
the method comprises, during the flight, a step of updating the weights of the branches of at least a part of the graph and a step of recalculating the best path in the graph.
the updating of the weights of the branches of the graph is performed according to a change of priority.
the updating of the branch weights of at least a part of the graph is performed based on receipt of modified weighting data for the weighting corresponding to the current priority.
the step of updating the weights of the branches of the graph includes the generation of prohibited branches based on a dynamically occurring prohibited zone.
the prohibited zone is determined by remote communication of the device with other equipment of which the position determines the prohibited zone.
the other equipment is another unmanned aerial device.
the prohibited zone is a prohibited altitude level.
the other equipment is associated with a temporary intervention on the site.
the calculation of the best path is performed according to an agility constraint of the device.

According to a third aspect, a method for steering an unmanned aerial device is proposed, comprising the following steps:
determining a path by the determination method defined above,
applying at least one trajectory relaxation factor,
determining an allowable trajectory deviation as a function of the relaxation factor, and
applying a trajectory correction instruction only when an actual measured trajectory deviation exceeds the allowable trajectory deviation.

Advantageously but optionally, the relaxation factor is determined from at least one data item representative of one of the following pieces of information: current accuracy of a GPS unit installed on the device, wind, response of the device to the steering commands, size of the device, type of device.

According to a fourth aspect, a method for steering an unmanned aerial device is proposed, comprising the following steps:
determining a path by the determination method defined above,
measuring a dynamic characteristic of the device during the flight,
dynamically determining a new path according to the evolution of said dynamic characteristic.

This method advantageously but optionally includes the following additional features, taken individually or in any combination that a person skilled in the art would consider to be technically compatible:
said dynamic characteristic comprises at least one characteristic from the available energy on board and a behavioral anomaly.
the graph includes nodes designating landing stations or zones, and the step of dynamically determining the new path takes into account the positions of the landing station or zone nodes.
the step of dynamically determining the new path also takes into account the status (free, occupied) of the station or landing zone nodes.
the method includes a modification of the priority in case of a behavioral anomaly.
   An unmanned aerial device is further proposed, characterized in that it comprises digital processing and wireless communication circuits designed to implement all or part of any of the above methods, and a computer program, suitable for loading on board an unmanned aerial device, characterized in that it comprises instructions suitable for implementing all or part of any of the above methods.

### BRIEF DESCRIPTION OF THE DRAWINGS

Other aspects, objectives and advantages of the present invention will become clearer from the following detailed description of preferred embodiments thereof, given by way of non-limiting example and made with reference to the appended drawings, in which:

FIG. 1 is a plan view of a simplified site on which a UAV must operate,

FIG. 2 is an elevation view of the simplified site in FIG. 1,

FIG. 3 is a perspective view of the simplified site in FIGS. 1 and 2,

FIG. 4 is a view similar to FIG. 1, showing safety zones surrounding no-fly zones,

FIG. 5 is a view similar to FIG. 2, showing safety zones surrounding no-fly zones,

FIG. 6 is a plan view at a first altitude, illustrating a possible spatial breakdown of the simplified site at this altitude,

FIG. 7 is a plan view at a second altitude, illustrating a possible spatial breakdown of the simplified site at this altitude,

FIG. 8 is a plan view at a third altitude, illustrating a possible spatial breakdown of the simplified site at this altitude,

FIG. 9 is a plan view at a fourth altitude, illustrating a possible spatial breakdown of the simplified site at this altitude,

FIG. 10 illustrates a theoretical path via points of the spatial breakdown of FIG. 6,

FIG. 11 shows a corrected path established from the points in FIG. 10, and

FIG. 12 illustrates the overall architecture of a drone system suitable for implementing the invention.

### DETAILED DESCRIPTION OF PREFERRED EMBODIMENTS

### Introduction

In the following, we will use the term “drone” (or UAV—Unmanned Aerial Vehicle) to refer to an unmanned, remote-controlled and/or self-steered aerial device, preferably equipped with a rotating wing, although drones with lifting wing(s) are also covered.

We will describe here different aspects of the calculation and tracking of dynamic and safe paths in a complex and potentially dangerous three-dimensional flight space. We will then describe an architecture capable of implementing these functions, in particular in terms of the distribution of tasks related to these functions between the flying devices and the ground.

The system to which the invention applies includes one or more drones capable of flying in a given space, as well as one or more ground charging stations. The invention focuses in particular on the search for a path under constraints in this space, the observance of the calculated trajectory, as well as the re-evaluation of the trajectory and the destination.

More particularly, the present invention aims at allowing a drone to move with the greatest safety in a three-dimensional space, part of the topology of which is known in advance. This knowledge makes it possible to establish a representation of the flight space, to take into account both the dynamic changes of this space and the changes of state of the device such as the battery level or the appearance of behavioral anomalies, and also to take into account the priorities given to the flight by the user or automatically according to a given context (shortest path, greatest energy efficiency, etc.).

According to one feature, a processing unit uses mission data comprising in particular the coordinates of a starting point and the coordinates of a point to be reached to construct a list of waypoints optimized from the point of view of a number of criteria, including flight safety.

This list of waypoints is recalculated over time whenever the topology of the terrain changes, new information becomes available or previously available information is no longer available.

This method aims at taking into account in real time and in an automatic way effects as varied as a drop in the quality of the network in a certain zone of the space, an obligation of one-way travel in a certain zone, the coordinates of an available charging station, the presence of other drones in the vicinity of the trajectory, etc.

The three-dimensional flight space provided as input data is a finite volume that can contain volumes where flight is prohibited. In order to prevent positioning uncertainties, static safety margins are taken into account: the volume of the flight space is decreased by reducing the spatial extension of its outer boundaries and by increasing the spatial extension of the boundaries of the prohibited volumes it contains.

The authorized flight space, defined as the exclusion of the volumes representing the unauthorized flight zones from the total volume, is then subdivided into a set of elements all contained within the authorized flight space. For each of these elements, a characteristic point is chosen. A graph is constructed by connecting the points between nearest neighbors. Advantageously, a weighting is associated with each of the branches and depends on the constraints imposed on the system and is described below. This weighting can be oriented, i.e., two different points can be associated with a branch, depending on the direction in which it must be traversed. When the destination is indicated by the user, the graph is traversed to find the optimal path according to the constraints.

Once the path has been calculated, i.e., once the flight plan has been established, the path is followed by the UAV. In order to ensure the observance of the calculated trajectory, a volume containing the trajectory is calculated according to the environmental conditions, the flight parameters (speed, acceleration, etc.). This volume is derived from the application of a non-isotropic relaxation factor of the trajectory and corresponds to a mandatory flight volume for the UAV following said trajectory. The relaxation factor is calculated periodically and the mandatory flight volume is modified accordingly to take into account dynamic changes in the conditions of modification of said relaxation factor. The weighting associated with the branches of the graph is periodically recalculated and the path between the current position and the destination that minimizes the “cost” of the path according to one or more criteria is recalculated. The notion of path cost is determined by a high-level priority chosen by the user: priority to the shortest path time, to the highest average path speed, to increased safety. When the new path crosses the volume associated with the previous path, then the relaxation factor is recalculated and the mandatory flight volume recalculated accordingly. The behavior of the UAV is monitored and when an anomaly is detected a change of destination can occur, and the UAV then heads to the safety zone, defined a priori, maximizing flight safety.

### Representation of the Flight Space

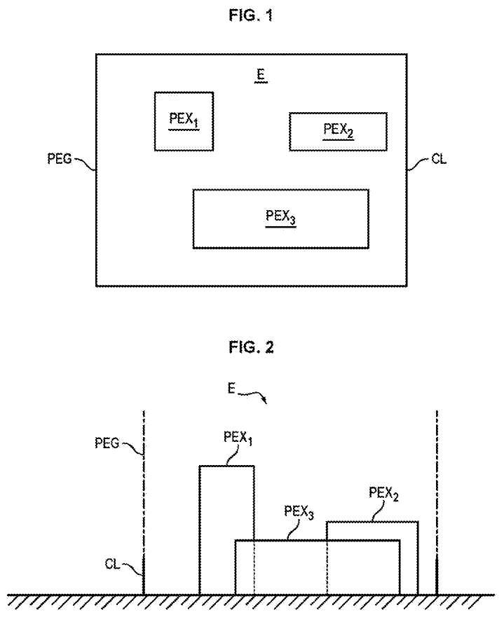

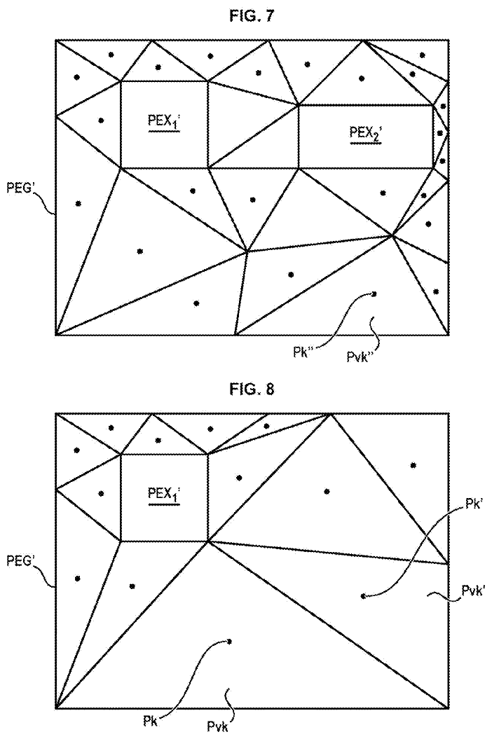

A method for path finding and path construction and tracking will now be described in detail with reference to FIGS. 1 to 11.

Referring first to FIGS. 1 to 3, the representation of the flight space E can be provided in three dimensions by considering it as a so-called “encompassing” polyhedron PEG (typically a cylinder of vertical director leaning on the limits of a site, here a fence CL) entirely containing a set of other so-called “excluded” polyhedra, here for the sake of simplification rectangular parallelepipeds PEX1, PEX2 and PEX3, the volume of which is prohibited for flight. These polyhedra can represent, for example, buildings, industrial installations, tanks, or parking or work zones. In order to take into account both the uncertainty of the position measuring instruments and the errors introduced by the three-dimensional model itself, static safety margins for both the encompassing polyhedron and the excluded polyhedra are calculated by determining a predefined increase in the size of the excluded polyhedra and a predefined decrease in the size of the encompassing polyhedron. The increase or decrease distance can be chosen in different ways using for example the known error of the positioning system. It can be different in the two horizontal dimensions and the vertical dimension. It is typically approximately 5 m.

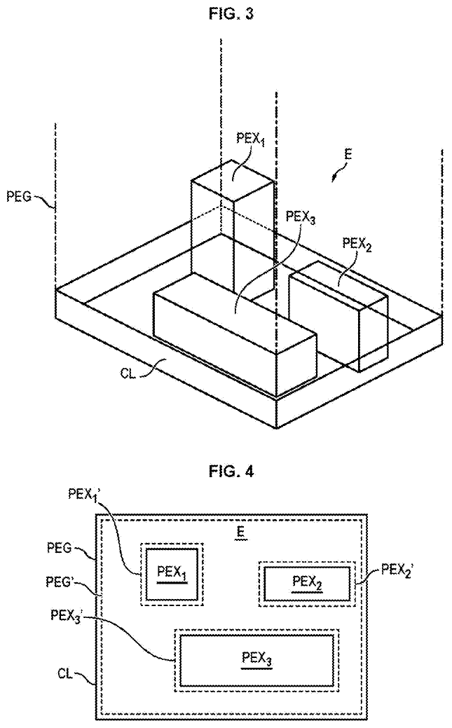

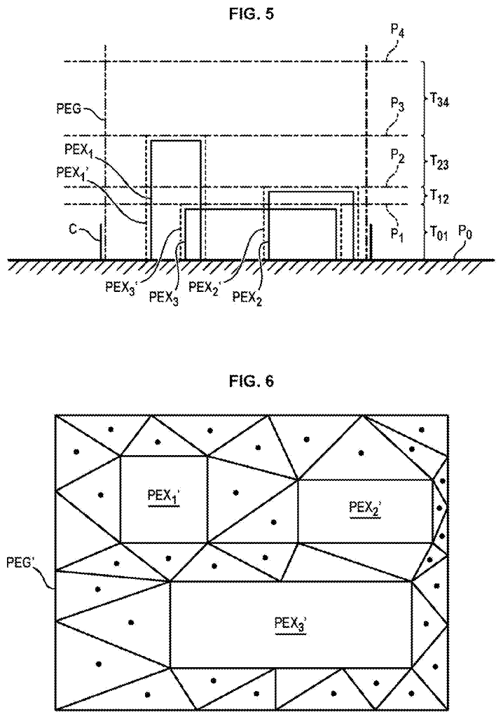

Thus, the references PEG′ and PEX1′, PEX2′ and PEX3′ designate in FIGS. 4 and 5 these “expanded” polyhedra after correction.

Referring now to FIGS. 5 and 6 to 9, the three-dimensional model of the flight space is here seen as the superposition of horizontal layers at different altitudes. Horizontal slices of fixed altitudes are created between horizontal planes located at the minimum and maximum altitudes of each of the polyhedra contained in the flight space. Here a plane P0 corresponds to the common minimum altitude of the three excluded polyhedra PEX1, PEX2, PEX3, while planes P1 to P3 correspond to the maximum altitudes in the increasing direction of the excluded polyhedra, namely PEX3, PEX2 and PEX1. The intersection between each plane and each polyhedron itself forms a polygon. Here the polyhedra are of constant horizontal section over their entire height. In the case of polyhedra of variable section, the projection of the polyhedron in the planes at the level of its widest section for the slice considered is determined by calculation.

The design of the three-dimensional model may also include a plane P4 (see FIG. 5) determined according to a maximum flight altitude of the UAVs, this plane being carried forward to a near-infinite altitude in the absence of such a limitation.

The flight space is modeled by a 2.5 dimensional space constituted by a set of slices, here T01, T12, T23 and T34 of constant horizontal sections, which are delimited respectively by the pairs of planes P0-P1, . . . , P3-P4, of which the limits are externally those of the corrected encompassing polyhedron PEG′ and internally those of the corrected excluded polyhedra PEX1′ to PEX3′ which have intersections with these slices, each one of these slices defining over its entire height an authorized flight zone.

FIGS. 6 to 9 illustrate respectively the cross sections of the four slices based on the model in FIGS. 1 to 5.

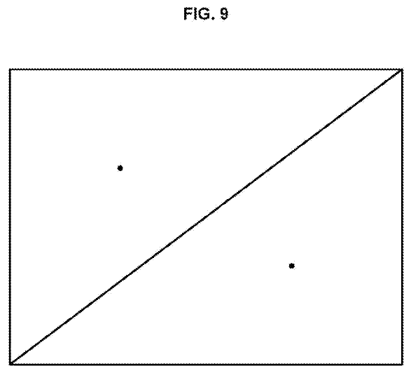

It can be seen in FIG. 9 that the slice T34 of greatest altitude does not contain any excluded polygons.

This flight space is entered by one or more UAVs, which interact with one or more charging stations located in accessible zones of the flight zone. Emergency landing zones can also be taken into account in the definition of the flight space. They correspond to zones that may or may not contain a charging station and are selected zones in which a UAV can land safely. A charging station must necessarily be located in an emergency landing zone: in case of a problem during the landing of a UAV in the station, the UAV has a fallback solution that is quickly and safely accessible. In the current description, an emergency landing zone can be located above an obstacle, but cannot be located at the same level.

The creation of the model of the site to be traversed also includes the positioning, carried out with the help of an appropriate user interface, of charging stations for UAVs, and, if necessary, of emergency landing zones separate from the charging station zones.

Advantageously, this positioning is carried out by taking into account the safety margins of the prohibited zones, so as to avoid a UAV having to enter such a prohibited zone during an emergency landing.

Subdivision of the Flight Space into Individual Elements and Construction of a Representation of the Flight Space in the Form of a Graph

In this step, the horizontal plane of the authorized flight zone in each of the aforementioned slices is subdivided by a processing system into a set of individual elements or paving stones PVk thus constituting a paving of the authorized flight zone in that slice. The paving can be performed in different ways. Advantageously, a Delaunay triangulation or one of its variants (see in particular https://fr.wikipedia.org/wiki/Triangulation_de_Delaunay) is used for this paving, the paving stones thus being all triangular in shape.

Advantageously, a constrained Delaunay triangulation is used (see for example Christophe Lemaire. Delaunay triangulation and multidimensional trees. Image synthesis and virtual reality [cs.GR]. Ecole Nationale Supérieure des Mines de Saint-Etienne; Université Jean-Monnet—Saint-Etienne, 1997. French. NNT: 1997STET4021; tel-00850521, chapter 1.5).

An advantage of Delaunay triangulation is that it is not very demanding in terms of the computational resources required to perform the triangulation, so the subdivision into tiles can be performed on board the UAV.

In addition, the constrained triangulation makes it possible to ensure that the result of the triangulation respects a particular shape in some places because the individual elements of the model can intersect (case for example of a prohibited flight zone in the middle of an authorized flight zone).

Once the triangulation has been carried out, the processing unit determines the coordinates of a characteristic point Pk for each paving stone. A possible choice is to take the center of mass of the paving stone. Indeed, by definition, the center of mass of a triangular paving stone resulting from a Delaunay triangulation is necessarily located inside this paving stone, and thus in the authorized flight zone of the considered horizontal slice Txy.

The processing unit then constructs a graph, the nodes of which are each of these characteristic points Pk. Each node has as properties a node identifier Ik and its three coordinates Xk, Yk, Zk in an orthonormal three-dimensional space. The branches of the graph include branches connecting the closest nodes located in the same slice, and on the other hand branches connecting the closest nodes in two neighboring slices. The nodes constituted as closest in the same slice are advantageously the characteristic points of triangles adjacent by one of their sides (simplicity of construction). The closest nodes of two adjacent slices are the nodes with the shortest calculated mutual distance, where a node in a given slice may have one or more branches connecting it to one or more nodes in the next higher branch (when available), and one or more branches connecting it to one or more nodes in the next lower branch (when available). As a general rule, the processing unit does not generate a branch between nodes of slices that are not immediately adjacent, but exceptions may exist for particular site configurations. Furthermore, in all cases a branch can only be generated between two nodes if it does not intersect with the inner and outer edges of the slices under consideration, and the processing unit checks this condition by applying simple geometric rules to each branch generation.

FIGS. 6 to 9 illustrate the Delaunay triangulations and associated characteristic points in each of the slices of the simplified model used thus far.

Once the graph is established (or during its construction), the processing unit assigns to each of these branches a base weight which is proportional to the length of the branch, determined from the coordinates of the two nodes it connects.

In a preferred embodiment, this base weight can be affected by a path direction correction coefficient, to favor a path in one direction rather than another, by decreasing the base weight and increasing it in the opposite direction, possibly until it is large enough that no path in that direction can be proposed during the search for the best path by the processing unit (see below).

For branches connecting nodes located at different altitudes, the base weight can be corrected by an altitude factor determined by the difference in altitude between the two nodes. The value of this correction factor can be chosen heuristically, and is positive in the upward direction and negative in the downward direction. In this way, a change in altitude is favored in the downward direction, and disfavored in the upward direction.

Other factors of dynamic variation of the weight of the branches will be described in the following.

### Search and Update Path

The processing unit installed in the drone is able to receive as input data the coordinates of a desired destination on the site, this destination being either entered by a user and communicated to the drone by the available communication means, or determined automatically depending on other processing operations. According to its current position and the destination data, the processing unit installed in the UAV relies on the graph defined as described above, loaded in the memory of each UAV when it is installed on site, to construct the path leading to said destination, and to execute the control commands making it possible to follow the path.

The path determination is broken down into two parts:
the first consists in the search for an overall path in the whole flight space;
the second consists in the construction of a trajectory making it possible to follow the path found in the previous step.

When the destination is received by the drone, the processing unit scans the pavement determined as described above to identify the triangular paving stone encompassing the destination, in the altitude slice immediately below the altitude of the destination. This search can be performed by browsing a table listing all the geometric characteristics of the paving, as determined by the Delaunay triangulation.

If such a paving stone is found in the table, then the destination is indeed contained within the authorized flight zone. In other words, destinations outside the authorized flight zone are unreachable by construction.

Once the destination is validated, the processing unit initiates a graph browsing process, of a type known in itself, to find the shortest path in the graph by minimizing the sum of the weights of the branches to be browsed. This process can be based for example on a known algorithm such as A* or Dikjstra (see for example https://dzone.com/articles/from-dijkstra-to-a-star-a-part-2-the-a-star-a-algo).

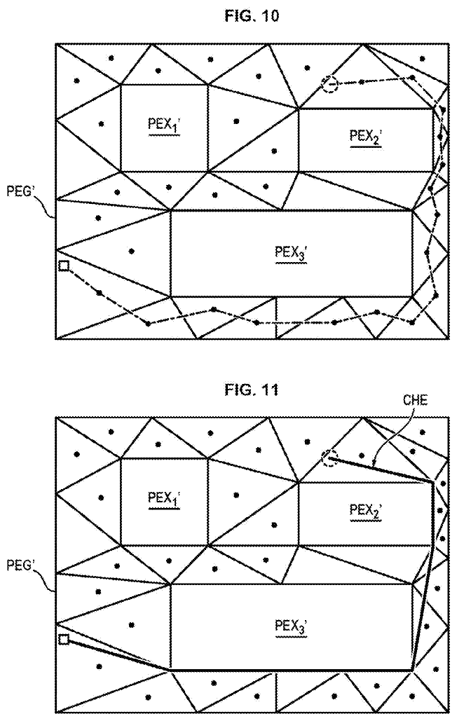

FIG. 10 illustrates an obtained basic path CHB, which is a broken line of which the intermediate points or crossing points are the characteristic points of the graph for which the sum of the weights is minimized.

The main purpose of this basic path CHB is, in complex environments, to determine the optimal route between the prohibited zones with respect to this weight minimization.

On the basis of this basic path, the processing unit establishes an effective path CHE, an example of which is shown in FIG. 11, by performing a number of operations on the basic path, in particular:
eliminating certain crossing points using alignment tests (if three crossing points PPn−1, PPn and PPn+1 are, to an approximation, on the same line, then the intermediate crossing point PPn is eliminated);
eliminating certain crossing points by calculating a straight line connecting crossing points PPn−1 and PPn+1 located on either side of a crossing point PPn, determining whether this line intersects one or more expanded prohibited zones, and eliminating the crossing point Pn in the event that this test is negative;
refining the path by removing some unnecessary intermediate points through a weight sum reduction approach; this process involves for example a dichotomous approach: if we consider a section of path constituted by three crossing points PPn−1, PPn and PPn+1, the point PPn is replaced by a point PPn′ of the segment PPn−1-PPn such that the weight associated with the branch PPn′-PPn+1 is lower than the weight associated with the branch PPn-PPn+1, this search for the point PPn′ being carried out by dichotomy; an effective path CHE of which the total weight of the branches is minimized is thus generated.

At the end of these steps, the processing unit uses the data of the effective path CHE to construct a flight volume or corridor that the UAV must respect. This volume is constructed by taking into account a relaxation factor around the path CHE.

This relaxation factor is determined from the maximum wingspan of the UAV, increased by a factor that can be either uniform and depend on the nature of the site, or variable depending on the location of the path CHE and in particular its distance from no-fly zones (after expansion), or the sum of a uniform factor and a variable factor.

In a basic embodiment, taking this relaxation factor into account in the calculation of the required flight corridor involves the calculation of a set of truncated cones placed end to end around the path CHE, the radius of the base of each truncated cone being equal to the relaxation factor. The flight volume is constructed step by step around the path to be followed CHE.

This flight corridor can either be calculated after the path CHE has been established, for the whole of the path, or can be calculated dynamically during the flight of the UAV. It will be recalculated each time the UAV determines a new path CHE after variation of the weights of the branches of the graph.

Periodically, the UAV compares its actual current position with the geometric data of the flight corridor. When this comparison detects a deviation from the flight corridor (notably due to external factors such as strong wind, a temporary GPS location problem, etc.), a corrective flight instruction is applied to the autopilot based on the measured position deviation.

It should be noted that other factors may be relevant to the static or dynamic determination of the authorized flight corridor, in particular:
UAV agility factors (type of wing, minimum speed—in the case of a fixed wing—and maximum speed, maximum acceleration, etc.),
characteristics of installed sensors (Lidar, laser, etc.),
   these factors influencing, in particular, the ability of the UAV to dynamically detect and avoid collisions. In general, the narrower the flight corridor, the weaker these abilities are.

Moreover, once the dimension of the flight corridor is established, it can be foreseen that the UAV, within this corridor, adopts a trajectory which is different according to these or other parameters, whether dynamic or static. Thus, the determination of the trajectory can be influenced by the value of various parameters having the effect of favoring the shortest possible trajectory, or one making it possible to maximally reduce the execution time, or the one remaining the greatest possible distance from the obstacles.

According to another feature, it can be foreseen that an exit from the flight corridor causes, rather than a corrective action on the autopilot aimed at allowing the UAV to recover its corridor, a new calculation of the path and then of the associated flight corridor.

In practice, when a mission order comprising destination data is received by the UAV, the installed processing unit initiates the first global path search. Then, during the flight, communication channels between the UAV and other equipment (ground equipment, sensors, other UAVs, etc.) allow the processing unit to update the weights of the branches of the graph.

At the same time, either at a given frequency (for example, once a second), or each time a weight is modified, the processing unit of the UAV carries out a new path search between its current position and the destination indicated at the start.

It is also possible, during the flight, that the UAV receives or determines a new destination, and in this case a new path between its current position and the new destination is calculated, and updated as described above.

Once the path is found, the flight corridor is calculated and memorized so that it can be accessed by a local trajectory planner.

If the installed processing unit has information about the autonomy of the battery or batteries of the UAV, this information is compared with the sum of the weights of the path CHE to determine whether the UAV has sufficient autonomy to reach the destination, with an appropriate margin of error.

If flight is possible, the local trajectory planner, at a determined frequency and for example 50 times per second, applies flight instructions to the autopilot to make the UAV move in the corridor. As described above, this planner also tests, preferably at the same frequency, for possible lane departures and applies appropriate corrective instructions to the autopilot.

It should also be noted that this trajectory planner can take into account, either statically or dynamically, a maximum authorized speed in the corridor.

### Adjustment of the Weights of the Branches of the Graph

In the above description, the base weights associated with the branches of the graph representing the flight space are calculated as being proportional to the distance between the nodes that the branches connect.

Each UAV likely to fly on a site contains in its memory the data of this graph, with the basic weights, and as already seen the installed processing unit will determine the flight corridor to follow to reach a given destination.

At the same time, the communication means of the UAV with the ground, or even with other UAVs flying on the same site, or even with sources of information on the site (sensors, etc.) or sources of external information (weather data, etc.) allow the UAV to collect data likely to affect the weight values.

On a mathematical level, these data can be of scalar field type or vector field type.

A scalar field corresponds, for example, to a variable such as a quality rating of the communication network between the UAVs and the ground, temperature, humidity, etc.

These data are scalar in the sense that they are not oriented and affect all the weights of the graph in the same way.

For example, a particularly low temperature may lead to increasing the base weights by a given multiplier, to account for the fact that the UAV's autonomy at low temperatures is reduced due to a loss of battery efficiency.

On the other hand, the wind can be represented as a vector field, with each point or region of the flight space being associated with a vector of which the orientation represents its direction, and of which the norm represents its strength. The reception of a vector field (or of a vector applicable to the current location of the drone) makes it possible to recalculate the weights of the branches of the graph by a scalar product function, the branch being also regarded as a vector of which the orientation corresponds to its direction and of which the norm represents the basic weight.

In the case where the value of the wind vector along a given branch changes depending on the position in the branch, the processing unit determines an average of the vector products at different points of the branch.

It is noted that the granularity of a vector field that can affect the weights can vary widely. For example, in the case of wind, it is possible to use a single wind vector for the whole site, accessible from a connected anemometer or an external weather source, or different wind vectors depending on the zones of the site, whether the “local” wind is measured by sensors or determined by simulation.

Note that the component of the weight of a branch resulting from this calculation is oriented: the force of a wind not perpendicular to a branch decreases the base weight in one direction (wind against path), and increases the base weight in the other (wind with path).

A module for updating the weights of the branches of the graph modifies the preference weights each time new data from external constraints are available. To minimize the risk of error, any new path calculation request during a weight update operation is made on the basis of the current graph before updating, a copy of which is kept for this purpose.

### Modification of the Path According to a Priority Given to the Flight—Different Types of Weights

When setting up a mission, either by a user or in an automated way, the mission data can advantageously include a type of priority to reach the destination set by the mission.

For example, four types of priorities can be provided, namely:
minimization of the absolute distance to be covered,
minimization of the travel time,
minimization of the energy consumption,
risk minimization, with possible sub-categories according to the type of risk (on people, on goods, etc.).

In general, the current value of the weight of a branch for a given direction of travel is obtained by combining the base weight (length of the branch) with the various corrections made by one or more scalar fields and/or by one or more vector fields, as described above.

Priority management implies the ability to give each branch a different nature or weight value.

In the case where the priority is the minimization of the absolute distance, the path search is performed on the weighted graph with the basic weights or basic weights corrected for example with a wind vector.

In order to take into account a priority of the travel time minimization type, the distance weight (base weight, corrected or not) assigned to each branch can be corrected by a coefficient related to the maximum speed allowed in this branch.

Advantageously, this correction is carried out by including in the data of the site to be modeled a mapping of authorized speeds (in particular according to the type of nearby or overhead equipment, a risk related to people, etc.).

Then, once the structure of the graph is established, the processing unit assigns to each branch a maximum authorized speed information according to the location of this branch in the speed map. From the base weight (length of the branch) and this maximum speed information, the processing unit calculates a minimum travel time weight (the one obtained for the maximum authorized speed), by multiplying the base weight possibly corrected by a scalar or vector field by a coefficient which is smaller the higher the authorized speed, and vice versa.

If the mission includes this priority of minimizing travel time, the search for the best path is no longer based on weights representing the distance, but on these travel time weights.

Another mapping that the system can advantageously use is a mapping defining zones with different levels of risk. This risk mapping makes it possible, for example, to take into account the presence of personnel or zones of personnel traffic, the dangerousness of the different installations, etc. In the same way as for the mapping of authorized speeds, the processing unit alters the weight of each branch according to the risk rating of the zone in which the branch is located, thus, in the end, disfavoring paths crossing high-risk zones compared to paths crossing lower-risk zones.

In the case where the priority of the mission is the minimization of energy consumption, one possible approach is to determine a density of waypoints. In this regard, the greater the number of waypoints, the more frequent the direction and speed changes of the UAV will be, which is an important factor for energy consumption.

The determination of the path can then be achieved not by searching for the shortest path in distance or in time, but by determining a set of possible paths all having a sum of weights in time or in distance lower than a threshold, and to select the path which has the minimum number of crossing points.

Finally, if the priority is flight safety, each branch can be assigned a risk factor derived from its proximity to equipment constituting a prohibited zone. The greater the proximity, the higher the risk factor. Once the graph structure is obtained, this “risk” weight is determined by calculating the distance of each generated branch from the nearest prohibited zone, and by assigning to the distance weight (base weight after possible correction by scalar or vector field) a multiplier coefficient that is all the greater the shorter this distance (the coefficient being typically equal to 1 for all the branches of which the distance from a prohibited zone is greater than a given threshold).

The best path from the point of view of flight safety is then the one that minimizes the sum of the risk weights.

To further refine this priority management, it is possible to combine the base weights (possibly corrected by scalar and/or vector fields) with the aforementioned speed, energy consumption and risk factors in different measures, so as to adapt the importance of each alteration to the mission priority.

For example, it is possible to set an order of priorities (for example safety then speed then energy) and to modulate the impact of the corresponding weight correction factors accordingly.

An example for calculating the weight of a branch of the graph will now be described.

The general formula for calculating this weight is given by:

wAB;j=SUMi(Yi;jGi(A,B))

where
A and B are nodes of the graph that can be connected by a straight line without intersection with the interior of a prohibited zone (and if necessary without contact with its edge),
j is a priority factor,
Gi(A,B) are functions representing a contribution to the weight calculation,
Yi;j is a factor associated with a contribution.

In a specific example, three contributions to the weight calculation will be considered, namely three functions G1, G2 and G3;
G1(A,B) represents the distance between the points A and B,
G2(A,B) represents the average quality of the GPS positioning signal between points A and B,
G3(A,B) represents the consideration of risk zones.

The mathematical formulation of these three functions can respond to different approaches that it is not necessary to detail here.

Now consider two priorities:
j=1: Shortest distance traveled,
j=2: Consideration of risk zones.

For each of these two priorities, the system chooses the contribution of the three functions G1, G2, G3 to the branch weight by changing the value of the corresponding parameter Yi;j.

Thus, in the above case where the priority is given only to a shortest traveled distance (j=1), it is possible to use:
Yi=1=1
Yi=2, 3=0

In the case where priority is given only to the consideration of risk zones (j=2), it is possible to use:
Yi=1, 2=0
Yi=3=1

Of course, coefficients Yi;j with values different from 0 and 1, ensuring a combined consideration of different priorities, can be used.

### Modification of the Flight Space According to an Imposed Traffic Direction

At any time, the user or an external factor can impose a zone, especially a passage zone between two prohibited zones, in which a certain direction of traffic is made mandatory.

In this case, the weights associated with the branches of the graph extending at least partially into this zone are modified in such a way as to leave intact the weights associated with the branches in the direction that respects this direction of flow, and to make the weights in the opposite direction infinite or quasi-infinite (from the point of view of the mathematics of the graph, giving them a very high value).

It should be noted here that, as a general rule, a UAV must be able to return to its departure zone. However, depending on the flight direction topology imposed, it is possible that the one-way criterion does not allow this. To ensure that the UAV can return to its departure point, even in a one-way traffic context, the existence of a high but not infinite weight for the route in the prohibited direction nevertheless allows the UAV to travel through a one-way zone in the prohibited direction when it has no other choice.

### Modification of the Flight Plan in Response to UAV Dynamic Characteristics

From the moment the UAV is powered up, a module for estimating the available flight time is launched and determines this flight time according to the state of charge of the battery, recent measurements of consumption in flight, the ambient temperature, etc.

When the UAV is on a mission, the processing unit calculates at a given rate, for example once a second, a so-called “emergency” path between its current position and the position of the nearest available charging station (or other landing zone). As long as the time needed to cover this path is less than the estimate of remaining time indicated by the above-mentioned module, the UAV continues its mission.

When the estimated available flight time becomes equal to the flight time to reach the nearest charging station (possibly within a safety margin), then the UAV processing unit causes a mission abort by replacing the path currently travelled on that mission with the emergency path calculated from the current position and the nearest landing position, so as to return to it and land.

According to another approach, the emergency path is imposed in response to technical anomalies observed by the UAV during the mission. Thus, the autopilots are generally able to provide various data concerning the health of the drone, such as the accuracy of the position determination circuit (the so-called EKF circuit for “Extended Kalman Filter”), the vibration level, etc.

From the moment the UAV is powered up, an anomaly detection module connected to the EKF circuit and to a vibration sensor (typically part of its inertial unit) is activated. For all types of data analyzed, this module estimates whether or not the received values are in the range of acceptable values. One possible implementation is to calculate a simple average over a given time window for each type of data received, and to compare it with a stored range of acceptable values. If an average value falls outside this range, the emergency path is automatically calculated, loaded and followed.

### Modification of the Flight Space: Prohibited Altitudes, Presence of Other UAVs

Knowing that several UAVs can fly on the same site, it is expected in accordance with this functionality that the presence of other UAVs in flight on the site is taken into account in the establishment of the path or the dynamic modification of it.

This functionality is advantageously implemented in addition to anti-collision devices that can equip UAVs, such as laser or Lidar, the effectiveness of which implies a direct visibility of the obstacle and which moreover can require significant digital processing resources.

More precisely, rather than recalculating the structure of the graph by considering a drone as a mobile no-fly zone, a solution can consist in receiving at the level of a UAV the current position of another UAV in flight in the vicinity, in identifying the branches of the graph located at a distance lower than a threshold of this position, and in assigning to the weights of the branches thus identified a very high multiplier factor, so that a recalculated path after updating the weights avoids the branches in question.

This aspect makes it possible to significantly increase flight safety when a fleet of UAVs is able to operate on the same site.

### Architecture

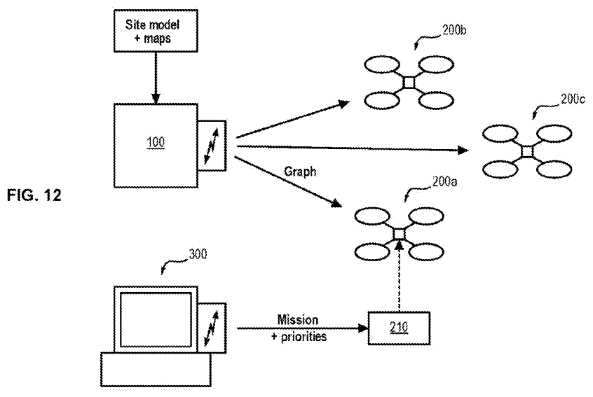

FIG. 12 illustrates an architecture that allows the implementation of the different aspects described above.

A first processing unit 100 receives site model data and associated maps. From this data, it performs the expansion of the no-fly zones, determines the authorized flight zones at the different altitudes, performs the subdivisions for example by Delaunay triangulations at each of the altitudes, generates the points of the graph from the coordinates of the individual paving stones, and interconnects these points, on the one hand, in each horizontal plane corresponding to an altitude and, on the other hand, between adjacent horizontal planes.

For each branch of this graph, its length is calculated from the coordinates of the points it joins, to thus determine its base weight.

The data of this graph are transmitted by the adapted communication channels to each of the UAVs 200a, 200b, 200c, etc. likely to circulate on the site, where said data are stored.

Each time the site environment changes (appearance or disappearance of a no-fly zone for example), an updated graph is determined and transmitted to each UAV.

A mission is typically initiated by transmitting mission data from a ground station 300, separate from or part of the processing unit 100, to a given UAV, here 200a.

The processing unit 210 installed in this UAV receives mission data, typically including:
the coordinates of a destination,
one priority for the flight, or several ordered priorities,
other mission parameters, in particular shooting instructions during movement and hovering, etc.

The processing unit 210 installed in the UAV also receives, either before the start of the mission or periodically including during the flight, scalar and/or vector data likely to affect the base weights of the branches.

Based on the priority data and scalar and/or vector data, as well as any data affecting the traffic directions, the processing unit 210 calculates the effective weights of the different branches, and determines the base path CHB based on the graph data provided with its effective weights, the current coordinates of the UAV (starting point), and the received destination data.

The processing unit 210 then determines the effective path CHE.

The ability of the UAV to perform the mission, based on its autonomy, is then measured.

If there is sufficient autonomy, the mission can then start, and during the flight, the installed processing unit monitors possible corridor departures and applies the necessary corrective actions to the autopilot, receives dynamic data likely to affect the weights of the branches of the graph, recalculates the path as needed, recalculates the feasibility of the mission according to the updated autonomy, and monitors possible anomalies on board, likely to cause the replacement of the current mission path by an emergency path.

Of course, the present invention is by no means limited to the foregoing description and many variations are possible.

In particular:
flight data can be collected and assembled for access by a learning process to determine, when the constraints are similar to previously encountered constraints, the path to follow by experience rather than by calculation;
mission data can include not only destination data, but also mandatory waypoint data, especially for planned monitoring;
the various processes described in the above, whether carried out on the ground or on board, can be carried out in different processing architectures; in particular, the creation and updating of the graph from the site model can be carried out on board each of the UAVs, if the computing power is suitable.

1. A modeling method using digital processing of a three-dimensional environment in order to establish pathways for unmanned aerial devices optimized according to different priorities, characterized in that the method comprises the following digital processing steps:
(a) providing a three-dimensional model of volumes (PEXi) in which flight is prohibited,
(b) subdividing the model into individual elements (PVk),
(c) determining a center (Pk) for each individual element,
(d) establishing and memorizing a graph, the nodes (Pk, Ik) of which are formed by at least one portion of said centers, and the branches of which are weighted by the distances between the nodes and by at least one weighting associated with a given priority.

2. The method according to claim 1, wherein the priorities include at least two priorities from an absolute distance priority, a travel time priority, an energy consumption priority, and a risk priority.

3. The method according to claim 1, wherein at least one of the weightings depends on a constraint affecting the set of branches.

4. The method according to claim 3, wherein said constraint comprises a constraint vector affecting all branches.

5. The method according to claim 4, wherein the constraint vector is a wind vector, each branch having a pair of weights associated respectively with the direction of travel and each weight being distinctly subject to the wind vector.

6. The method according to claim 1, wherein said weighting is such that different weights are assigned to the same branch depending on the direction of travel, so as to generate preferred directions of travel.

7. The method according to claim 1, wherein said weighting is based on a mapping defining different levels of constraints depending on the location in a flight space.

8. The method according to claim 7, wherein the constraint levels are included in a group comprising a maximum authorized speed constraint and a risk constraint.

9. The method according to claim 8, wherein the constraint is able to assume a value such that the corresponding zone becomes a no-fly zone.

10. The method according to claim 1, wherein step (a) comprises providing a three-dimensional model having volumes (PEXi) in which flight is physically impossible, and reprocessing this model with static safety margin data.

11. The method according to claim 10, wherein step (a) comprises subdividing the three-dimensional model into horizontal slices (Txy), the projection of the volumes onto a horizontal plane being the same throughout the thickness of each slice, and implementing a subdivision into individual elements in each horizontal plane.

12. The method according to claim 11, wherein the subdivision is performed by triangulation.

13. The method according to claim 12, wherein the triangulation is a Delaunay triangulation.

14. The method according to claim 11, wherein step (d) comprises establishing branches of the graph between nodes located in adjacent horizontal planes by a distance minimization approach.

15. A method for determining, by an unmanned aerial device, a path between two points in a three-dimensional space modeled by a graph obtained by the method according to claim 1, characterized in that it comprises the following steps:
determining a priority for the route,
taking into consideration or establishing a given graph corresponding to the determined priority, and
defining the route, on board the device, by a best path calculation in said given graph.

16. The method according to claim 15, wherein the step of weighting the branches of the graph is implemented by remotely receiving a starting graph with unweighted branches, and weighting, on board the device, said branches according to priority.

17. The method according to claim 15, which comprises, during flight, a step of updating the branch weights of at least a portion of the graph and a step of recalculating the best path in the graph.

18. The method according to claim 17, wherein the updating of the weights of the branches of the graph is performed according to a change in priority.

19. The method according to claim 17, wherein the updating of the weights of the branches of at least a portion of the graph is performed based on receipt of modified weighting data for the weighting corresponding to the current priority.

20. The method according to claim 15, wherein the step of updating the weights of the branches of the graph comprises generating prohibited branches based on a dynamically occurring prohibited zone.

21. The method according to claim 20, wherein the prohibited zone is determined by remote communication of the device with other equipment of which the position determines the prohibited zone.

22. The method according to claim 21, wherein the other equipment is another unmanned aerial device.

23. The method according to claim 22, wherein the prohibited zone is a prohibited altitude landing.

24. The method according to claim 23, wherein the other equipment is associated with a temporary site intervention.

25. The method according to claim 15, wherein the calculation of the best path is performed according to an agility constraint of the device.

26. A method for steering an unmanned aerial device, comprising the following steps:
determining a path by the method according to claim 15,
applying at least one trajectory relaxation factor,
determining an allowable trajectory deviation as a function of the relaxation factor, and
applying a trajectory correction instruction only when an actual measured trajectory deviation exceeds the allowable trajectory deviation.

27. The method according to claim 26, wherein the relaxation factor is determined from at least one piece of data representative of one of the following pieces of information: current accuracy of a GPS unit installed on the device, wind, response of the device to steering commands, size of the device, type of device.

28. A method for steering an unmanned aerial device, comprising the following steps:
determining a path by the method according to claim 15,
measuring a dynamic characteristic of the device during the flight,
dynamically determining a new path according to the evolution of said dynamic characteristic.

29. The method according to claim 28, wherein said dynamic characteristic comprises at least one characteristic from on-board available energy and a behavioral anomaly.

30. The method according to claim 28, wherein the graph comprises nodes designating landing stations or zones, and wherein the step of dynamically determining the new path takes into account the positions of the landing station or zone nodes.

31. The method according to claim 30, wherein the step of dynamically determining the new path also takes into account statuses (free, occupied) of station or landing zone nodes.

32. The method according to claim 29, which comprises modifying the priority in the event of a behavioral anomaly.

33. An unmanned aerial device, characterized in that it comprises digital processing and wireless communication circuits designed for the implementation in whole or in part of the method according to claim 1.

34. A computer program, suitable for being loaded on board an unmanned aerial device, characterized in that it comprises instructions suitable for implementing all or part of the method according to claim 1.
